(19) United States
(12) Patent Application Publication
(10) Pub. No.: US 2016/0070439 A1
(43) Pub. Date: Mar. 10, 2016

(54) ELECTRONIC COMMERCE USING AUGMENTED REALITY GLASSES AND A SMART WATCH

(71) Applicant: International Business Machines Corporation, Armonk, NY (US)

(72) Inventors: James E. Bostick, Cedar Park, TX (US); John M. Ganci, JR., Cary, NC (US); Sarbajit K. Rakshit, Kolkata (IN); Craig M. Trim, Sylmar, CA (US)

(21) Appl. No.: 14/477,127

(22) Filed: Sep. 4, 2014

(51) Int. Cl. G06F 3/0484; G06Q 30/06; G06T 19/00; G06F 3/01; G06F 3/16

(52) U.S. Cl. CPC G06F 3/04842; G06F 3/017; G06F 3/013; G06F 3/167; G06T 19/006; G06Q 30/0641

(57) ABSTRACT

In an approach for electronic commerce using augmented reality glasses and a smart watch, a computer receives a configuration associating a user gesture to a command. The computer determines whether a user of the augmented reality glasses selects an object in a first electronic commerce environment and, responsive to determining the user selects an object, the computer determines whether the user performs a first gesture detectable by a smart watch. The computer, then, determines whether the first gesture matches the user gesture and, responsive to determining the first gesture matches the user gesture, the computer performs the associated command.

### BACKGROUND OF THE INVENTION

The present invention relates generally to the field of augmented reality glasses, and more particularly to the use of augmented reality glasses and a smart watch for electronic commerce.

Augmented reality (AR) is a live, direct or indirect, view of a physical, real-world environment whose elements are augmented by computer-generated sensory input such as visually perceivable content, including graphics, text, video, global position satellite (GPS) data or sound. Augmentation is conventionally in real-time and in semantic context with environmental elements, for example, the addition of current, real-time sports scores to a non-related news feed. Advanced augmentation such as the use of computer vision, speech recognition and object recognition allows information about the surrounding real-world to be interactive and manipulated digitally. In many cases, information about the environment is visually overlaid on the images of the perceived real-world.

Some augmented reality devices, rely, at least in part, on a head-mounted display, for example, with sensors for sound recognition. An example of existing head-mounted display technology or augmented reality glasses (AR glasses) uses transparent glasses which may include an electro-optic device and a pair of transparent lenses, which display information or images displayed over a portion of a user's visual field while allowing the user to perceive the real-world. The displayed information and/or images can provide supplemental information about a user's environment and objects in the user's environment, in addition to the user's visual and audio perception of the real-world.

### SUMMARY

According to aspects of the present invention a method, a computer product, and a computer system are disclosed for electronic commerce using augmented reality glasses and a smart watch. A computer receives a configuration associating a user gesture to a command. The computer determines whether a user of the augmented reality glasses selects an object in a first electronic commerce environment and, responsive to determining the user selects an object, the computer determines whether the user performs a first gesture detectable by a smart watch. The computer, then, determines whether the first gesture matches the user gesture and, responsive to determining the first gesture matches the user gesture, the computer performs the associated command.

### BRIEF DESCRIPTION OF THE DRAWINGS

FIG. 1 is a functional block diagram illustrating an augmented reality data processing environment, in accordance with an embodiment of the present invention;

FIG. 2 is a flowchart depicting operational steps of an electronic commerce application on augmented reality glasses for electronic commerce using augmented reality glasses and a smart watch within the augmented reality data processing environment of FIG. 1, in accordance with an embodiment of the present invention; and

FIG. 3 depicts a block diagram of components of the augmented reality glasses executing the electronic commerce application, in accordance with an embodiment of the present invention.

### DETAILED DESCRIPTION

Embodiments of the present invention recognize that several electronic commerce (E-commerce) applications for augmented reality glasses (AR glasses) have been developed using tactile and audio commands. Touch screens, in smart phones or touch sensors on the AR glasses, may be used in conjunction to or as an alternative to audio sensors and speech recognition to command AR glasses. Embodiments of the present invention utilize gaze focal point detection to identify an object by identifying a focal point in the user's field of vision. Furthermore, embodiments of the invention use a smart watch or other wearable computing device with one or more sensors which can detect one or more muscle movements for a gesture such as a finger motion or a hand gesture. The smart watch sends sensor data for a detected gesture to AR glasses. The sensor data may include detected muscle movement data for a gesture. The gesture correlated to the sensor data of the muscle movements received by AR glasses may be configured to correspond to a user command. For example, a gesture associated with sensor data for one or more muscle movements may be configured to select an object or product.

Embodiments of the invention provide a capability to identify a selected object or product in an augmented reality view, such as an internet site or an on-line store database viewed using AR glasses. Embodiments of the present invention provide the ability to view or scan barcode data of a product in a real world environment such as a brick and mortar store. Additionally, embodiments of the present invention provide the ability to capture an image of an object in a real world environment such as a brick and mortar store for possible selection, identification, shopping cart addition, and other object related actions. Furthermore, embodiments of the present invention provide the capability to search product data, to search product attributes, to search multiple websites, local or on-line databases and real world environments, to select an object or product, to move an object or product to an on-line or augmented reality shopping cart for purchase and to store and retrieve selected products and search results using AR glasses and a smart watch. Additionally, embodiments of the present invention provide a memory management function for recall of data on previously viewed or searched objects or products such as product images, product identification, product attributes, product type and product location.

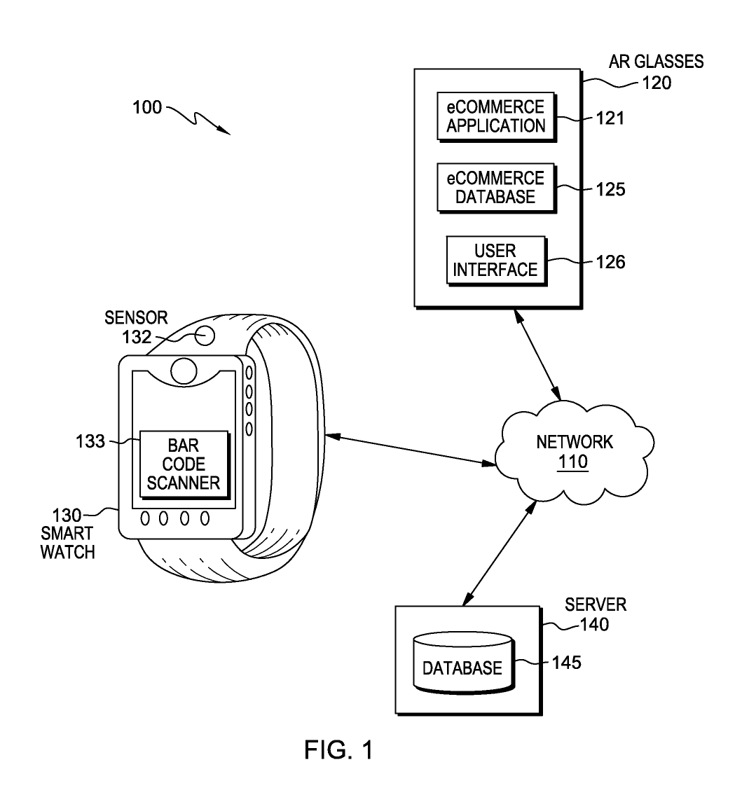

The present invention will now be described in detail with reference to the Figures. FIG. 1 is a functional block diagram illustrating an augmented reality data processing environment, generally designated 100, in accordance with one embodiment of the present invention. FIG. 1 provides only an illustration of one implementation of the present invention and does not imply any limitations with regard to the environment in which different embodiments may be implemented. Modifications to the depicted environment may be made by those skilled in the art without departing from the scope of the invention as recited by the claims.

Augmented reality data processing environment 100 includes augmented reality glasses (AR glasses) 120, smart watch 130 and server 140 all connected over network 110. Network 110 can be, for example, a telecommunications network, a local area network (LAN), a wide area network (WAN), a virtual local area network (VLAN) such as the Internet, or any combination of the three, and can include wired, wireless, or fiber optic connections. In general, network 110 can be any combination of connections and protocols that will support communications between AR glasses 120, smart watch 130 and server 140.

Server 140 may be a management server, a web server, or any other electronic device or computing system capable of receiving and sending data. In other embodiments, server 140 may represent a server computing system utilizing multiple computers as a server system, which may be a distributed computing environment created by clustered computers and components acting as a single pool of seamless resources such as a cloud computing environment. In another embodiment, server 140 may be a laptop computer, a netbook computer, a personal computer (PC), a desktop computer, a personal digital assistant (PDA), a smart phone, or any programmable electronic device capable of communicating with AR glasses 120 and smart watch 130 via network 110. Server computer 140 includes database 145. While depicted as a single server and a single database in FIG. 1, in some embodiments, server 140 may include multiple databases.

Database 145 resides on server 140. In an embodiment, database 145 may reside on AR glasses 120. In another embodiment, database 145 may reside on smart watch 130 or another device (not shown) within augmented reality data processing environment 100 accessible via network 110. Database 145 may be implemented with any type of storage device capable of storing data that may be accessed and utilized by server 140, such as a database server, a hard disk drive, or a flash memory. In other embodiments, database 145 may represent multiple storage devices within server 140. In an embodiment, database 145 is a store database such as an on-line product catalog. Database 145 may include product images, product names, product specifications or product attributes including product availability and barcode information or a product barcode. An application within augmented reality data processing environment 100, for example, E-commerce application 121 on AR glasses 120, may access database 145 which may be any database including any store database, multi-vendor database, multiple advertisement database, or product database. E-commerce application 121 may retrieve information on an object or product from database 145 via network 110.

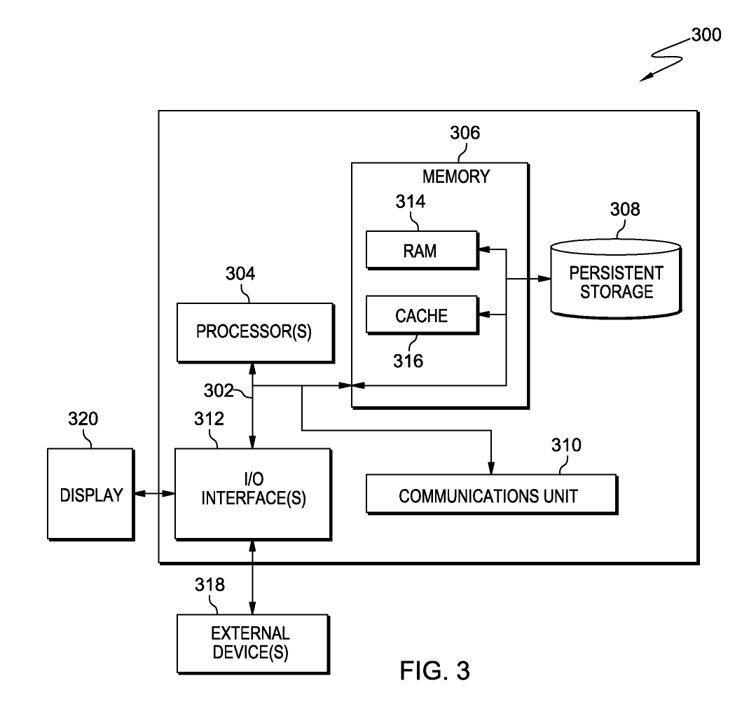

AR glasses 120 may be an augmented reality computing device, a wearable computer, a desktop computer, a laptop computer, a tablet computer, a smart phone, or any programmable electronic device capable of communicating with smart watch 130 and server 140 via network 110 and with various components and devices within augmented reality data processing environment 100. In the exemplary embodiment, AR glasses 120 are an augmented reality computing device implemented as a wearable computer. Wearable computers such as AR glasses 120 are especially useful for applications that require more complex computational support than just hardware coded logics. In general, AR glasses 120 represents a programmable electronic device, a computing device or a combination of programmable electronic devices capable of executing machine readable program instructions and communicating with other computing devices via a network, such as network 110. Digital image capture technology such as a digital camera or image scanning technology may be provided with AR glasses 120 in addition to digital image projection to the user in AR glasses 120, creating the augmented reality standard in augmented reality device technology. AR glasses 120 may be capable of sending and receiving data such as sensor data from smart watch 130 via network 110. AR glasses 120 include E-commerce application 121, E-commerce database 125, and user interface (UI) 126. AR glasses 120 may include internal and external hardware components, as depicted and described in further detail with respect to FIG. 3.

E-commerce application 121 uses eye gaze data received by E-commerce application 121 from AR glasses 120 to track user eye movement and uses data from one or more sensors included in smart watch 130 to capture user gestures or motions such as a finger motion or an arm motion associated with smart watch 130. In an exemplary embodiment, E-commerce application 121 allows a user to select an object using gaze focal point tracker capability. E-commerce application 121 may select an object with a gaze focal point tracker which uses the direction of a user gaze and binocular vision principles to extrapolate a focal point of the user's vision. E-commerce application 121 may receive sensor data from sensor 132 on smart watch 130 for muscle movements associated with a gesture such as bending a finger or turning a wrist or curling all fingers. E-commerce application 121 may use a gesture associated with muscle movements detected by a sensor, such as sensor 132 on smart watch 130, to configure a user identified command or action such as “move to shopping cart” or “select object”. E-commerce application 121 provides a method for on-line and in-store shopping using an augmented reality data processing environment to enhance on-line and in-store shopping. The user initially configures E-commerce application 121 to receive sensor data of movements associated with a gesture and use the gesture to perform command such as “scroll to the next product” or “drag and move the product to the shopping cart”. E-commerce application 121 can receive sensor data from sensor 132 in smart watch 130 of a gesture and executes the corresponding command, for example, “add to shopping cart” or “scroll to next product”. In addition, E-commerce application 121 may store in E-commerce database 125 the data of objects viewed by the user. The data may include images of the objects selected, the attributes of the object selected and the location of an object viewed and selected by the user of AR glasses 120. E-commerce application 121 may retrieve from E-commerce database 125 data regarding the object selected, including the attributes of a previously viewed object, the location of a previously viewed object from the currently accessed database or from a previously accessed database.

E-commerce application 121 provides the user the capability to select another or second object or to search stored data on previously viewed or selected objects. The object may be a product, a person, a building, product data or other object for example. The object discussed in the following embodiments of the invention will focus on an object such as a consumer product, however, the object should not be limited to “products” but may include other objects. While the method discussed herein focuses on on-line and in-store shopping, some embodiments of the present invention may be applied to other areas of technology. For example, an object selected may be a building that may be selected by gaze focal point tracking and the configured gesture may be for identification of, for example, a name of the object, other object information identification such as a history of the building, or an identification of information from a social network regarding the selected object.

E-commerce database 125 resides on AR glasses 120. In an embodiment, E-commerce database 125 may reside on smart watch 130. In another embodiment, E-commerce database 125 may reside on server 140 or another device (not shown) in augmented reality data processing environment 100. E-commerce database 125 stores data regarding the identification of and related information of objects, products or locations that the user of AR glasses 120 may access or view. E-commerce application 121 may retrieve information on objects previously viewed from E-commerce database 125. E-commerce database 125 may receive updates, from E-commerce application 121, regarding new objects viewed, products or locations viewed. E-commerce database 125 may also receive, via network 110, additional information related to objects, products and locations from database 145. For example, E-commerce application 121 may store updates or additional information from database 145 to E-commerce database 125. In another example, server 140 may send updates or additional information to E-commerce database 125. Database 145, located on server 140, and database 125 on AR glasses 120 may be implemented with any type of storage device capable of storing data that may be accessed and utilized by server 140, such as a database server, a hard disk drive, or a flash memory.

UI 126 provides an interface between a user and a computer program, such as E-commerce application 121, and may utilize input such as sensor data from smart watch 130. A user interface, such as UI 126, may be an interface, a set of commands, a data input such as sensor data generated in response to a user gesture, a voice signal input using speech recognition, a touch input using a touch screen or button through which a user communicates the control sequences or commands to a program and the interface can provide the information (such as graphic, text, and sound) that a program presents to a user. In one embodiment, UI 126 may be the interface between AR glasses 120 and E-commerce application 121. In other embodiments, UI 126 provides an interface between E-commerce application 121 and database 145, which resides on server 140. In one embodiment, UI 126 may be the interface between AR glasses 120 and smart watch 130. In an embodiment, the user interface input technique may utilize data received from one or more sensors which may be located on smart watch 130. In another embodiment, user interface input technique may utilize barcode scan data received from a barcode scanner on smart watch 130. In an embodiment, the user input technique may utilize data received from sensors in AR glasses 120. In another embodiment, the user interface input technique may utilize data received from one or more tactile sensors such as a touch screen, a button, or a touch sensitive area on smart watch 130. Additionally, audio commands or speech recognition commonly applied in AR glasses 120 may be used by UI 126 to receive user input that may be used, for example, to configure E-commerce application 121.

Smart watch 130 may be a wearable computer, a personal digital assistant, a smart phone or a watch with sensing capability, such as with a motion sensor or a barcode scanner capable of communication with AR glasses 120. Smart watch 130 may be, for example, a hand gesture capturing device, such as a computing device capable of detecting motion or movement. Wearable computers are electronic devices that may be worn by the user under, with or on top of clothing, as well as in glasses, jewelry, hats, or other accessories. Smart watch 130 may be any other electronic device with sensing capability including a hand gesture sensing, muscle movement detection, gesture sensing, barcode scanning and communication capability such as the ability to send and receive data over network 110 or wirelessly over a local area network (WLAN) to AR glasses 120. In one embodiment, smart watch 130, with communication capability with an E-commerce application, such as E-commerce application 121, may include only a sensor 132. In another embodiment, smart watch 130 may include one or more sensors. As depicted, smart watch 130 includes sensor 132 and barcode scanner 133.

Sensor 132 may provide the capability to identify movement, for example, finger, hand, arm or muscle movement or a series of movements used in a user gesture such as a finger tapping movement. Barcode scanner 133 on smart watch 130 may be used, for example, to scan a barcode of a product in a brick and mortar store. Sensor data and barcode scan data may be sent over network 110 to AR glasses 120 or may be sent wirelessly via a local wireless network (WLAN). In another embodiment, smart watch 130 may be a wearable computer including, for example, E-commerce application 121 and E-commerce database 125, which can send and receive data from AR glasses 120 and server 140 and may include components and capabilities discussed with reference to FIG. 3. In an embodiment, smart watch 130 may be a bracelet, a wristband, one or more rings, or other apparel, decorative item or jewelry with sensors and data transmission that may or may not include barcode scanner 133. In some embodiments, smart watch 130 includes a touch screen, button or other tactile activated area for user input to smart watch 130 for communication to E-commerce application 121.

Sensor 132 resides in smart watch 130 and may be any device capable of capturing a user gesture such as a hand gesture, a finger movement, an arm movement, a muscle movement or other user movement associated with the sensor location. Sensor 132 may consist of one or more sensors or other devices capable of capturing a user's movement such as a finger, a hand, a muscle movement, an arm movement or a combination of one or more movements associated with a user gesture. Sensor 132 provides sensor data which may be electrical potential data, motion data, or any similar digital data associated with a user gesture as captured by one or more sensors such as sensor 132. In an embodiment, sensor 132 may sense the electrical activity produced by the user's muscles, for example, similar to sensors used in electromyography. In one embodiment, sensor 132 may be a sensitive motion sensor capable of detecting both fine motions created by a finger gesture or a gross movement such as an arm movement. In an exemplary embodiment, sensor 132 may be located on the user's wrist in smart watch 130. Sensor data for a user's gesture or motion may be sent to E-commerce application 121 via network 110 or a wireless local area network (WLAN).

As discussed above, barcode scanner 133 resides in smart watch 130. Barcode scanner 133 may be used to scan a product barcode to select and retrieve information on the scanned product when a user is in a brick and mortar store. Barcode scanner 133 may scan a product barcode and send the barcode scan data to E-commerce application 121 using network 110 or a wireless local area network. E-commerce application 121 may use the received barcode scan data to identify attributes of the product using database 145. E-commerce application 121 may send the barcode scan data directly using a wireless local area network to a local in-store database or in-store website or via network 110 to an internet website with access to a store database for the brick and mortar store where the product is residing. In an embodiment, barcode scanner 133 may reside on AR glasses 120. In one embodiment, barcode scan data scanned by barcode scanner 133 may be sent to E-commerce database 125 by E-commerce application 121. In an embodiment, barcode scanner 133 may reside on another device (not shown) capable of communicating with E-commerce application 121, E-commerce database 125, or database 145.

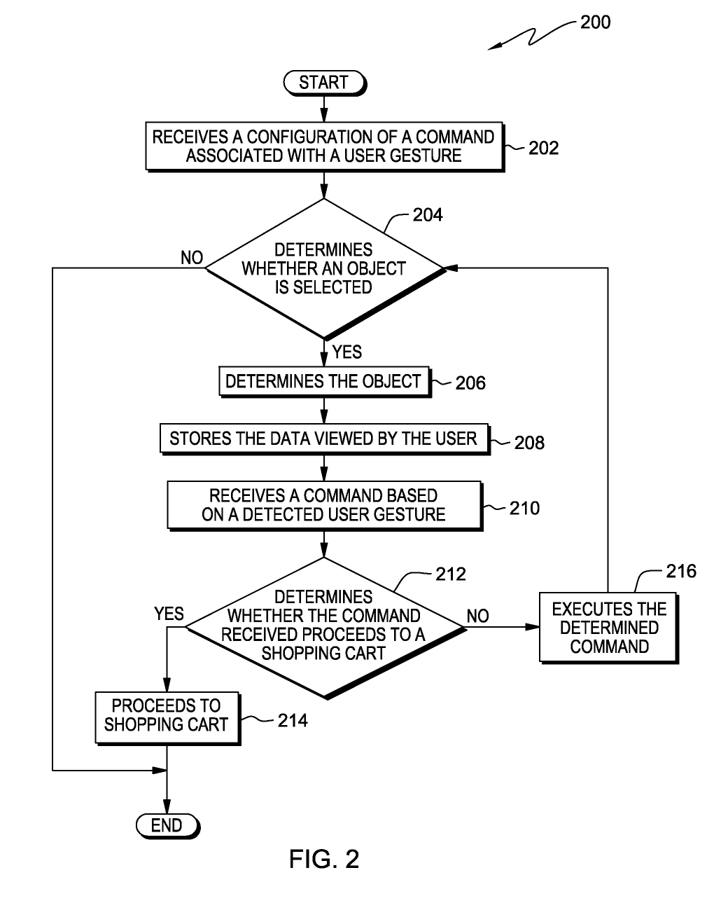

FIG. 2 is a flowchart 200 depicting operational steps of E-commerce application 121, on AR glasses 120 within augmented reality data processing environment 100 of FIG. 1, for electronic commerce using AR glasses and a smart watch, in accordance with an embodiment of the present invention.

In step 202, E-commerce application 121 receives a configuration of a command associated with a user gesture. A configuration of a command corresponding to a user gesture may be, for example, created by the user upon initialization of E-commerce application 121, stored by the user prior to use of E-commerce application 121, or the configuration may be a default setting for use of E-commerce application 121. The exemplary embodiment of the present invention includes smart watch 130 with one or more sensors to detect and track one or more gestures. Using E-commerce application 121, the user can configure a gesture to correspond to a command. Common tasks used in E-commerce, such as drag and drop of a product to add, change a quantity of, or remove the product from a virtual shopping cart, and complete a purchase, for example, may be initially configured and correlated by the user to specific gestures detected by sensor 132. When the user initially configures E-commerce application 121, smart watch 130 may send the sensor data, for example, muscle movement data for a user gesture to E-commerce application 121. The one or more sensors, such as sensor 132, which may be located on the watch band of smart watch 130, can detect one or more movements (e.g. finger, hand, arm or muscle movements) which correspond to a gesture configured for an action in E-commerce application 121. In another embodiment, upon receiving sensor data for a gesture from smart watch 130, the user may direct E-commerce application 121 to configure a command or an action to be executed in response to the gesture. In an embodiment, sensors may be used in AR glasses 120 to detect a head movement, which may correspond to a command in E-commerce application 121. The gesture may be configured by E-commerce application 121 according to a user input which may be an audio input or voice input received by AR glasses 120 using speech recognition software, natural language processing algorithms, or, a text input, such as a text, a note or another type of user input from another electronic or computing device which may be a laptop, a smart phone, a wearable computer, for example, smart watch 130. For example, a user may configure E-commerce application 121 to use a gesture to select an object. In another embodiment, E-commerce application 121 may retrieve information for associating a command with a user gesture from a database, for example, E-commerce database 125 or database 145.

When configuring a gesture to a command, a user may use a gesture such as a tapping motion of a pointer finger and say “select” to configure E-commerce application 121 to select an object currently viewed or determined to be selected by the user's focal point by gaze focal point tracker. The sensor data, which may include the muscle movements associated with a pointer finger tapping movement, may be configured such that E-commerce application 121 selects an object when the gesture, in this case, a point finger tap, is detected in sensor data from smart watch 130. The sensor data may include muscle movement for a gesture of the user's body such as a finger movement or a hand movement. In another example, E-commerce application 121 may be configured to scroll through an on-line website to search, for example, the website or a store database which may include product images, product descriptions, order information, product price or product specification data with a gesture such as a sliding motion of the user's left pointer finger

In decision block 204, E-commerce application 121 determines whether an object is selected. In an embodiment, when a user looks at or focuses on an object in an internet site such as a store catalog with AR glasses 120, E-commerce application 121, using a gaze focal point tracker, determines the object the user's gaze is focused on. E-commerce application 121 with a gaze focal point tracker utilizes input from AR glasses 120 on the spacing of the user's eyes or the spacing of the user's eye pupils in conjunction with the direction of the user's gaze to extrapolate a focal point of the user's gaze. The gaze focal point tracker using detected eye or pupil spacing, direction of view and binocular vision principals may identify the object in a locus or a focal point of the user's vision. In some embodiments, the user may open a web browser to view objects in a first electronic commerce vendor environment which may be an internet site where the object may be an image of an object or an image of a product viewed in the website using AR glasses 120. The object viewed, which may be selected, may also be text or words in an on-line internet site or an on-line product catalog. In another embodiment, the object viewed for possible selection could be a real-world product (e.g., on a store shelf in a brick and mortar store).

E-commerce application 121 may determine the object is selected in one or more ways (the “YES” branch of decision block 204). In an embodiment, E-commerce application 121 with gaze focal point tracker may be configured to select an object based on a threshold period of time the user focuses on the object. For example, an object identified by gaze focal point tracker as the focal point of the user's gaze may be selected by E-commerce application 121 when the user views the object for five seconds. In another embodiment, E-commerce application 121 may be initially configured to select an object in the user's focal point of vision only when object selection is requested by the user using a voice command (for example, “select product”) or a gesture. In the exemplary embodiment, the user may, for example, request an object selection by a gesture recorded by the one or more sensors in smart watch 130. In one embodiment, the user may also configure E-commerce application 121 to select an object using a gesture such as a nod of the head detected by sensors in AR glasses 120. In another embodiment, a user may use a tactile object selection method to request an object selection by using a touch screen, a button or an active area on smart watch 130 to identify object selection to E-commerce application 121. In one embodiment, an object in the real world, which may be a product in a store, may be selected by digitally capturing an image of the product using AR glasses 120 (e.g. using image scanning or digital camera capability in AR glasses). In an embodiment, E-commerce application 121 may select an object in a brick and mortar store when E-commerce application 121 receives data from a barcode scan of a product in a store from barcode scanner 133 included within smart watch 130.

E-commerce application 121 may determine no object was selected and ends processing (the “NO” branch of decision block 204). In an embodiment, E-commerce application 121 may receive direction from the user to exit the application from one of several methods. The user may input an audio or speech command to exit the application into UI 126. E-commerce application 121 may receive sensor data from the sensors on smart watch 130 of a gesture configured to end the application. E-commerce application 121 may receive direction to end the application based on a tactile selection of an icon, a button, or a menu item selection from a touch screen on smart watch 130 or a touch activated area on AR glasses 120 to exit the application, for example.

In step 206, E-commerce application 121 determines the selected object. An embodiment of the present invention uses image recognition of an image of an object to determine the selected object. The image of an object may be an image viewed in augmented reality on AR glasses 120 such as on an internet site which may be a store website, or the image of the object may be a scanned or digitally captured image of a real world object, for example, an image of product on a shelf captured by AR glasses 120. E-commerce application 121 may search a store website, a multi-vendor website, a multiple advertisement website or database, an internet site, an object recognition database, or perform an internet search for a correlated or matching object image or product image using image recognition. E-commerce application 121 may use image recognition techniques to match or correlate the digital image of the real-world object or an augmented reality image of a product in a store website with a digital image in a store internet website or another such database that stores information on the product. In some embodiments, E-commerce application 121 may search another store website, a multi-vendor website, a multiple advertisement website or database, an object recognition database or another internet site connected by either network 110 or another network for an image matching the object or product. In one embodiment, E-commerce application 121 may receive from smart watch 130 a barcode or barcode data from barcode scanner 133 of a product to identify the object or product. E-commerce application 121 can be connected to database 145 which may be the store database on server 140 via network 110. In an embodiment, E-commerce application 121 may be connected wirelessly by a local area network provided by the brick and mortar store accessing the store database which may include a product catalog and product information such as product attributes.

In step 208, E-commerce application 121 stores the data viewed by the user. In the exemplary embodiment, E-commerce 121 stores the data viewed by the user which may be, for example, an image of the selected object or a product description, in E-commerce database 125. E-commerce application 121 provides a memory management capability for data storage. For example, E-commerce application 121 may store or save a name of the selected object, save a price and product name, save a product by a user defined product type, an internet location, a store physical location, a product identification number, a product barcode, or a decoded product barcode for an object in E-commerce database 125. In an embodiment, the user may select the information or data to be saved in E-commerce database 125 by performing a gesture associated with a command to save the data or by a voice command (e.g., saying “save product” or “save product and price”) when focusing on the desired object, for example, when looking at an image of the object in an on-line store catalog, a digital image or photograph of the object, the real-life object in a brick and mortar store, or a description of a product, a product type, or a product attribute associated with the object, such as an estimated shipping time or a product price. In one embodiment, E-commerce application 121 may store data viewed by the user when bar code data from bar code scanner 133 is used to identify a product and/or associated product information of an object such as a product in a brick and mortar store. In another embodiment, E-commerce application 121 may store an image of a product in a brick and mortar store as captured by AR glasses 120. In some embodiments, E-commerce application 121 may store the data viewed by the user in the order in which the data was viewed.

In another embodiment, a user may save an object viewed by the user and associated data, by object type which may be, for example, a product type. For example, a record may be created for a product type such as “cameras” and a user may indicate by selecting an object, for example, using gaze focal point detection, a menu item, a product image, a product description or attribute displayed by AR glasses 120, using a gesture or saying “save in cameras”. In another embodiment, E-commerce application 121 may save or store a selected product when a user uses gaze tracker focal point detection to select a user configured icon or menu item in AR glasses 120 for the record or file for “cameras”. The memory management function provided by E-commerce application 121 may save the data viewed by the user. In an embodiment, the data viewed by the user and/or the selected objects may be sent to E-commerce database 125 and stored in the order in which the objects were selected. The data sent to E-commerce database 125 may be a product image, for example, from an internet website or an image of a product in a brick and mortar store or the data may be a product price saved and stored in the sequence as selected by the user. For example, a user selects a first lawn mower in a lawn and garden center store internet website and views the first lawn mower and price, then, the user moves to another internet shopping site, such as a department store website, and searches for and selects a second lawn mower to view the price. The second lawn mower selected may be stored by the memory management function in E-commerce application as a more recently viewed object in E-commerce database 125. E-commerce application 121 may be configured to store data viewed by a user or a selected object in E-commerce database 125 by any user defined category. E-commerce application 121 may be configured by the user to store selected objects by product type, by a store name, or by product availability, for example.

In step 210, E-commerce application 121 receives a command based on a detected user gesture. Sensor 132 on smart watch 130 detects a gesture and sends the sensor data to E-commerce application 121. E-commerce application 121, in response to receiving the sensor data for the gesture, determines what the associated command is for the gesture. In an embodiment, E-commerce 121 may receive a command to navigate to a second electronic commerce vendor environment such as a second store website to search for the selected object. In an embodiment, the user may configure the websites or databases to be searched and may include the order in which to search the website or databases. For example, a user may wish to search three specified stores, for example, store A, store B, and store C starting with the user preferred store, which is identified as store A. E-commerce application 121 may be configured to search only these three stores. The order in which E-commerce application searches the three stores may be configured by the user. In addition, the user may configure the type of data retrieved from a store website or a database such as database 145. For example, a user may only want to look for shoes in the first and the third of the three stores (i.e. store A and store C) configured in the previous example. E-commerce application can then retrieve the data stored by the user (step 208). The stored data may be an image of a product, a scan of a barcode, a decoded barcode, a product description, or a product attribute, such as price, for example.

In one embodiment, E-commerce application 121 may retrieve stored data associated with selected objects in the reverse order in which the objects were selected or, in other words, retrieve the objects by sequential order of entry starting from the most recent object to the oldest selected object. For example, the user may click an icon labeled “review last item” and the memory function in E-commerce application 121 will show the price for the first lawn mower viewed previously at the lawn and garden center database in the previous example. In another embodiment, E-commerce 121 may retrieve from E-commerce database 125 data stored by a category. For example, data stored by the user may be searched by a user or other defined category such as a product type in E-commerce database 125 (e.g. “lawn mowers”). For example, a user may select to retrieve data associated with each object previously selected in a product type or category such as “high resolution printers”. Upon the user completing a review the retrieved data viewed by the user, E-commerce application 121 may return to step 204 to determine whether another object is selected by the user.

In decision block 212, E-commerce application 121 determines whether the command received is configured to proceed to a shopping cart. In the exemplary embodiment, based on the gesture and the associated command, E-commerce application 121 determines if the command received in response to the sensor data proceeds to the shopping cart. In step 214, E-commerce application 121 determines the command proceeds to the shopping cart (the “yes” branch of decision block 212) and executes the command to move the object to the shopping cart which is a virtual shopping cart. The object in the shopping cart may be purchased using, for example, shopping cart directed actions such as payment entry, address entry, shipping address, shipping method and other similar purchase related user data inputs. In one embodiment, a command based on a user's gesture may be a command to purchase an item which may include E-commerce application 121 connecting with an automated payment program. In an embodiment, the shopping cart may utilize another website or vendor for payment or financial transactions related to the purchase of an object. Upon proceeding to the shopping cart and completing a purchase, E-commerce application 121 ends processing. In other embodiments, upon proceeding to the shopping cart, E-commerce application 121 may return to determine whether an object is selected (decision block 204), or determine whether sensor data is received indicating a command to navigate to another website or store.

In step 216, E-commerce application 121 executes the determined command (the “no” branch of decision block 212). E-commerce application 121 executes the command determined in step 210. The command may be, for example, to scroll to the next page on the website or to add the object to the shopping cart. E-commerce application 121 performs the configured action or command for the gesture. For example, E-commerce application 121 receives from sensor 132 on smart watch 130 sensor data of gesture such as the muscle movements associated with a pointer finger tap and slide, and according to the pre-configured command (see step 202) for the gesture, E-commerce application 121 drags and drops the selected object to a location indicated by a length of the user's slide of the finger (i.e., the dragging of the product depicted and directed by a gesture such as the sliding motion of the user's finger). In another embodiment, E-commerce application 121 may use the gaze focal point tracker to identify the location, for example, a virtual shopping cart, where the object is to be dropped when the right pointer finger tap and slide is used. In another embodiment, a tactile or touch screen on smart watch 130 may be configured to perform an action such as to select an object, drag an object, select an image, a word or a line of text, or perform another pre-configured command. Upon executing the determined command, E-commerce application 121 proceeds to determine whether another object is selected (decision block 204).

FIG. 3 depicts a block diagram 300 of components of a computing device, for example, AR glasses 120, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

AR glasses 120 include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media.

E-commerce application 121, E-commerce database 125 and UI 126 can be stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of server 140 and smart watch 130. In these examples, communications unit 310 includes one or more network interface cards. Communications unit 310 may provide communications through the use of either or both physical and wireless communications links. E-commerce application 121 and database 125 may be downloaded to persistent storage 308 through communications unit 310.

I/O interface(s) 312 allows for input and output of data with other devices that may be connected to AR glasses 120. For example, I/O interface(s) 312 may provide a connection to external device(s) 318 such as a sensor on a smart watch, a keyboard, a keypad, a touch screen, and/or some other suitable input device. External device(s) 318 can also include portable computer readable storage media such as, for example, thumb drives, portable optical or magnetic disks, and memory cards. Software and data used to practice embodiments of the present invention, e.g., E-commerce application 121, sensor data from smart watch 130 and database 125 can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for electronic commerce using augmented reality glasses and a smart watch, the method comprising:
receiving, by one or more computing devices, a configuration associating a user gesture to a command;
determining, by one or more computing devices, whether a user of an augmented reality glasses selects an object in a first electronic commerce vendor environment;
responsive to determining the user selects an object, determining, by one or more computing devices, whether the user performs a first gesture detectable by a smart watch;
determining, by one or more computing devices, whether the first gesture matches the user gesture; and
responsive to determining the first gesture matches the user gesture, performing, by one or more computing devices, the associated command.

2. The method of claim 1, further comprising, responsive to determining the user selects an object, storing, by one or more computing devices, information associated with the object.

3. The method of claim 2, further comprising:
determining, by one or more computing devices, the user has navigated to a second electronic commerce vendor environment;
retrieving, by one or more computing devices, the information associated with the object; and
searching, by one or more computing devices, based, at least in part, on the information associated with the object, the second electronic commerce vendor environment for the object.

4. The method of claim 2, wherein storing information associated with the object further comprises storing a category of the object.

5. The method of claim 1, wherein receiving a configuration associating a user gesture to a command further comprises:
receiving, by one or more computing devices, sensor data corresponding to the user gesture from at least one sensor on the smart watch;
receiving, by one or more computing devices, a command from the user to be configured to the sensor data for the user gesture; and
configuring, by one or more computing devices, the command to be associated to the user gesture.

6. The method of claim 1, wherein determining whether the user of the augmented reality glasses selects an object further comprises:
determining, by one or more computing devices, an object of focus of the user by a gaze focal point tracker;
determining, by one or more computing devices, if the object of focus is viewed for a threshold period of time; and
determining, by one or more computer devices, the object is selected.

7. The method of claim 1, wherein determining whether the user of the augmented reality glasses selects an object further comprises receiving, by one or more computing devices, a barcode from the smart watch.

8. The method of claim 1, wherein determining whether the user of the augmented reality glasses selects an object further comprises receiving a voice command from the user.

9. The method of claim 1, wherein determining whether the user performs a first gesture detectable by a smart watch further comprises receiving, by one or more computing devices, sensor data from the smart watch, wherein the smart watch includes at least one sensor.

10. A computer program product for electronic commerce using augmented reality glasses and a smart watch, the computer program product comprising:
one or more computer readable storage media and program instructions stored on the one or more computer readable storage media, the program instructions executable by a processor, the program instructions comprising:
program instructions to receive a configuration associating a user gesture to a command;
program instructions to determine whether a user of an augmented reality glasses selects an object in a first electronic commerce vendor environment;
responsive to determining the user selects an object, program instructions to determine whether the user performs a first gesture detectable by a smart watch;
program instructions to determine whether the first gesture matches the user gesture; and
responsive to determining the first gesture matches the user gesture, program instructions to perform the associated command.

11. The computer program product of claim 10, further comprising, responsive to determining the user selects an object, program instructions to store information associated with the object.

12. The computer program product of claim 11, further comprising:
program instructions to determine the user has navigated to a second electronic commerce vendor environment;
program instructions to retrieve the information associated with the object; and
program instructions to search, based, at least in part, on the information associated with the object, the second electronic commerce vendor environment for the object.

13. The computer program product of claim 11, wherein program instructions to store information associated with the object further comprises program instructions to store a category of the object.

14. The computer program product of claim 10, wherein program instructions to receive a configuration associating a user gesture to a command further comprises:
program instructions to receive sensor data corresponding to the user gesture from at least one sensor on the smart watch;
program instructions to receive a command from the user to be configured to the sensor data for the user gesture; and
program instructions to configure the command to be associated to the user gesture.

15. The computer program product of claim 10, wherein program instructions to determine whether the user of the augmented reality glasses selects an object further comprises:
program instructions to determine an object of focus of the user by a gaze focal point tracker;
program instructions to determine if the object of focus is viewed for a threshold period of time; and
program instructions to determine the object is selected.

16. The computer program product of claim 10, wherein program instructions to determine whether the user of the augmented reality glasses selects an object further comprise program instructions to receive a barcode from the smart watch.

17. The computer program product of claim 10, wherein program instructions to determine whether the user of the augmented reality glasses selects an object further comprise program instructions to receive a voice command from the user.

18. A computer system for electronic commerce using augmented reality glasses and a smart watch, the computer system comprising:
one or more computer processors;
one or more computer readable storage media;
program instructions stored on the one or more computer readable storage media for execution by at least one of the one or more computer processors, the program instructions comprising:
program instructions to receive a configuration associating a user gesture to a command;
program instructions to determine whether a user of an augmented reality glasses selects an object in a first electronic commerce vendor environment;
responsive to determining the user selects an object, program instructions to determine whether the user performs a first gesture detectable by a smart watch;
program instructions to determine whether the first gesture matches the user gesture; and
responsive to determining the first gesture matches the user gesture, program instructions to perform the associated command.

19. The computer system of claim 18, further comprising, responsive to determining the user selects an object, program instructions to store information associated with the object.

20. The computer system of claim 18, wherein program instructions to receive a configuration associating a user gesture to a command further comprises:
program instructions to receive sensor data corresponding to the user gesture from at least one sensor on the smart watch;
program instructions to receive a command from the user to be configured to the sensor data for the user gesture; and
program instructions to configure the command to be associated to the user gesture.
